(19) United States
(12) Patent Application Publication
(10) Pub. No.: US 2026/0106713 A1
(43) Pub. Date: Apr. 16, 2026

(54) CLOSED-LOOP ANTENNA SELECTION FOR INTRA-BAND CARRIER AGGREGATION

(71) Applicant: QUALCOMM Incorporated, San Diego, CA (US)

(72) Inventors: Hyojin LEE, San Diego, CA (US); Yu ZHANG, San Diego, CA (US); Jing JIANG, San Diego, CA (US); Jing SUN, San Diego, CA (US)

(21) Appl. No.: 18/913,614

(22) Filed: Oct. 11, 2024

(51) Int. Cl. H04L 5/00; H04B 7/06

(52) U.S. Cl. CPC H04L 5/0051; H04B 7/0602; H04L 5/001

(57) ABSTRACT

Certain aspects of the present disclosure provide techniques for linking component carriers (CCs) for sounding reference signal (SRS) transmission(s) for a common antenna selection operation. A method generally includes obtaining a configuration for an antenna selection operation, the configuration indicating a link between at least two CCs of a plurality of CCs; sending a plurality of SRSs via the at least two CCs according to the configuration; and obtaining one or more metrics for the antenna selection operation, the one or more metrics being associated with the plurality of SRSs.

### INTRODUCTION

### Field of the Disclosure

Aspects of the present disclosure relate to wireless communications, and more particularly, to techniques for a closed-loop antenna selection operation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a configuration for an antenna selection operation, the configuration indicating a link between at least two component carriers (CCs) of a plurality of CCs; sending a plurality of sounding reference signals (SRSs) via the at least two CCs according to the configuration; and obtaining one or more metrics for the antenna selection operation, the one or more metrics being associated with the plurality of SRSs.

Certain aspects provide a method for wireless communications by a network entity. The method includes sending a configuration for an antenna selection operation, the configuration indicating a link between at least two CCs of a plurality of CCs; obtaining a plurality of SRSs via the at least two CCs according to the configuration; and sending one or more metrics for the antenna selection operation, the one or more metrics being associated with the plurality of SRSs.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIGS. 5A and 5B depicts example closed-loop antenna selection operations.

FIGS. 6A and 6B depict example antenna switching operations.

FIG. 7 depicts an example wireless communications network.

FIG. 8 depicts an example linkage between component carriers (CCs) for antenna selection.

FIG. 9 depicts an example process flow for communications in a wireless communications network between a network entity and a UE.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for a closed-loop antenna selection operation with sounding reference signal (SRS) transmissions using a link between component carriers (CCs).

A wireless communication system may include a number of devices and network entities employing techniques for exchanging information wirelessly. For example, a wireless communication system may include devices (e.g., user equipments (UEs)) and network entities (e.g., base stations (BS)) that wirelessly communicate data, control information, reference signals, etc. (e.g., according to various wireless communication system implementations). The wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

In certain wireless communications systems (e.g., 5G New Radio (NR) systems and/or any future wireless communications system), closed-loop feedback associated with a communication channel may be used to dynamically adapt communication parameters (e.g., modulation and coding scheme, beamforming, multiple-input and multiple-output (MIMO) layers, or the like) according to time varying channel conditions, for example, due to changes with respect to user equipment (UE) mobility, weather conditions, scattering, fading, interference, noise, etc. As an example, a UE may send one or more SRSs to a network entity, and the network entity may characterize the channel between the UE and the network entity based on SRS measurements. In some aspects, the network entity may determine a channel and/or beamforming precoder based on the SRS measurements. For example, the network entity may identify a channel and/or set of resource blocks (RBs) to allocate for the UE to use for subsequent uplink communications based on the SRS measurements.

In some aspects, the network entity may indicate configuration(s) of SRS resource set(s) to the UE to enable transmission of SRS(s) to the network entity. For example, the configuration(s) of the SRS resource set(s) may indicate one or more SRS resources (e.g., time-frequency resources configured for transmission of the SRS(s)) in the SRS resource set(s), a periodicity for the SRS resource set(s) (e.g., how often resources are allocated for transmission of the SRS(s) for the SRS resource set(s)), an aperiodic trigger value for activation of the SRS resource set(s), a periodicity of the SRS resource set(s), a usage for the SRS resource set(s), etc. In some aspects, for the aperiodic trigger value, the network entity may send an uplink grant to the UE that includes an SRS request field to indicate for the UE to send the SRS(s), where the SRS request field corresponds to a trigger value. Subsequently, the UE may send the SRS(s) to the network entity from an SRS resource set configured with the aperiodic trigger value that corresponds to the trigger value in the SRS request field. Additionally, the usage for the SRS resource set(s) may indicate a purpose for the transmission of the SRS(s). For example, the usage may indicate if the corresponding SRS resource set is used for beam management, codebook based or non-codebook based transmission, or antenna switching.

For the beam management usage, the network entity may use measurements of the SRS(s) configured for the SRS resource set to identify an optimal receive beam for the network entity to use for subsequent communications and/or to identify and indicate (e.g., to the UE) an optimal transmit beam for the UE to use for subsequent communications. For the codebook based transmission usage, the UE may send SRS(s) configured for the SRS resource set, where the SRS(s) are non-precoded, and the network entity may determine and indicate (e.g., to the UE) precoding weights (e.g., that have been selected from a codebook standardized in wireless communication standards) for the UE to use for sending one or more subsequent physical uplink shared channel (PUSCH) messages based on measurements of the non-precoded SRS(s). For the non-codebook based transmission usage, the UE may determine precoding weights (e.g., that are not constrained to a codebook standardized in wireless communication standards) for sending the SRS(s) configured for the SRS resource set based on measurements of downlink reference signals previously received from the network entity and may send the SRS(s) to the network entity using the determined precoding weights. Subsequently, the network entity may determine and indicate (e.g., to the UE) parameters for subsequent PUSCH transmission(s) for the UE, such as a number of layers for the PUSCH transmission(s) and/or which precoding weights to use, based on measurements of the SRS(s).

For the antenna selection usage, the network entity may indicate for the UE to send the SRS(s) of an SRS resource set via one or more specific antenna ports of the UE. Subsequently, the network entity may use measurements of the SRS(s) to determine and indicate (e.g., to the UE) which antenna ports for the UE to use for subsequent communications. For example, the network entity may indicate transmit antenna port(s) for the UE to use for sending subsequent uplink messages based on the measurements of the SRS(s), such as signal-to-noise ratio (SNR) measurements of the SRS(s) to determine which transmit antenna port of the UE corresponds to a higher SNR measurement. Additionally or alternatively, to deduce downlink channel characteristics at the network entity, the network entity may indicate for the UE to send the SRS(s) via each of one or more receive antenna ports. For example, certain UEs may be capable of outputting SRS(s) via a receive antenna port (e.g., an antenna which may be selectively coupled to a transmit path and a receive path) for downlink channel characterization. In some aspects, certain UEs may have more receive antenna ports than transmit path(s), and thus, the UE may switch which receive antenna port is coupled to a transmit path for transmission of the SRS(s) via the respective antenna port. Subsequently, the network entity may indicate receive antenna port(s) for the UE to use for receiving subsequent downlink messages based on the measurements of the SRS(s).

In some aspects, a UE may be configured with multiple CCs, where the multiple CCs include specific carrier frequencies used for wireless communications. For example, in a carrier aggregation (CA) scenario, the UE may communicate on multiple CCs corresponding to multiple (serving) cells in a same cell group. Each CC may include multiple bandwidth parts (BWPs), where the BWPs include subsets of time-frequency resources allocated in the CC for specific communications. Additionally, each SRS resource configuration and SRS resource set configuration may be associated with a single BWP. Subsequently, if the UE is configured with multiple CCs, then transmission and measurement of the SRS(s) may be performed in a per-CC manner.

One or more technical problems may arise for SRS transmission(s) and measurement(s) when the UE is configured with multiple CCs. For example, for intra-band CA (e.g., the multiple CCs are located in a same frequency band), common transmit chains (e.g., common radio frequencies (RFs)) and common antennas may be used by the UE to support the multiple CCs. That is, a connection and/or mapping from the transmit chains to the antennas may be common for all of the multiple CCs. As such, an antenna selection result may also be the same across all of the multiple CCs. However, a per-CC reporting of antenna selection results or a per-CC reporting of measurements for the SRS(s) may not be optimal and may create unnecessary signaling and/or computational complexity. For example, the network entity may provide separate reporting and/or separate signaling resources to indicate individual antenna selection results for each of the multiple CCs. Additionally, the UE may perform post-processing of the individual antenna selection results to acquire a common antenna selection result for the multiple CCs based on the per-CC reporting. Additionally or alternatively, an active antenna set discrepancy may occur between SRS transmission(s) in one CC and PUSCH transmission(s) in another CC. For example, in a certain time (e.g., symbol or slot), the UE may send SRS(s) via a first antenna and a second antenna in a first CC and may send a PUSCH on the second antenna and a third antenna in a second CC, such that the antenna selection results are based on different antennas in each CC.

Aspects described herein may overcome the aforementioned technical problem(s), for example, by providing a link between CCs for SRS transmission(s) to enable a common antenna selection operation. For example, a UE may receive a configuration for the common antenna selection operation, where the configuration indicates a link between the CCs. Accordingly, the UE may send SRS(s) to a network entity via the linked CCs, such as sending the SRS(s) via the linked CCs using a same antenna (e.g., based on a same port-to-antenna mapping). Subsequently, the UE may receive one or more metrics for the common antenna selection operation from the network entity based on measurements of the SRS(s) received via the linked CCs. In some aspects, the one or more metrics may include per-antenna SRS-reference signal received power (RSRP) measurements, antenna selection results common across the linked CCs, or a combination thereof. Additionally, the UE may send capability information to the network entity for the antenna selection operation.

In some aspects, the network entity may configure the link between the CCs based on a linkage identifier (ID) configured for SRS resource set(s) in each of the CCs. Accordingly, SRS resource sets with a same linkage ID across CCs may be linked to each other, such that SRS resources with a same resource ID in the SRS resource sets with the same linkage ID may be transmitted with a same port-to-antenna mapping and/or with same time-domain parameters. Additionally or alternatively, the network entity may configure the link between the CCs based on a CC group configuration. For example, the network entity may configure one or more CC groups that each include one or more CCs to apply the common antenna selection operation. Accordingly, SRS resource set(s) with a same set ID across the one or more CCs in a CC group may be linked together, and the UE may send SRS resources with a same resource ID in the linked SRS resource sets within the CC group with a same port-to-antenna mapping and/or with same time-domain parameters. Additionally or alternatively, when SRS resources in SRS resource sets of different CCs have a same time-domain resource configuration, the SRS resources may be linked to each other, such that the UE sends SRS(s) on the linked SRS resources using a same port-to-antenna mapping. In some aspects, the network entity may send an uplink grant to the UE, where the uplink grant indicates an SRS resource set configured with the common antenna selection operation and a slot for sending SRS(s) via the indicated SRS resource set, and the UE may send, in the slot, SRS(s) via the indicated SRS resource set and via one or more additional SRS resource sets linked to the indicated SRS resource set (e.g., according to one of the options described above).

The techniques for linking CCs for SRS transmission(s) to enable a common antenna selection operation may enable improved wireless communications performance, such as reduced signaling overhead, reduced computational complexity, and/or the like. For example, signaling overhead may be reduced by enabling the network entity to send common antenna selection results across multiple CCs rather than individual antenna selection results per-CC, based on performing measurements of the SRS transmission(s) across the linked CCs rather than individually performing measurements of SRS transmission(s) on each CC. Additionally, the computational complexity at the UE may be reduced by the UE receiving the common antenna selection results across the multiple CCs rather than the individual antenna selection results per-CC and not performing post-processing of the individual antenna selection results to derive the common antenna selection result. In some aspects, the reduced computational complexity may also reduce power consumption at the UE based on the UE not performing the post-processing, which may extend a battery life of the UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

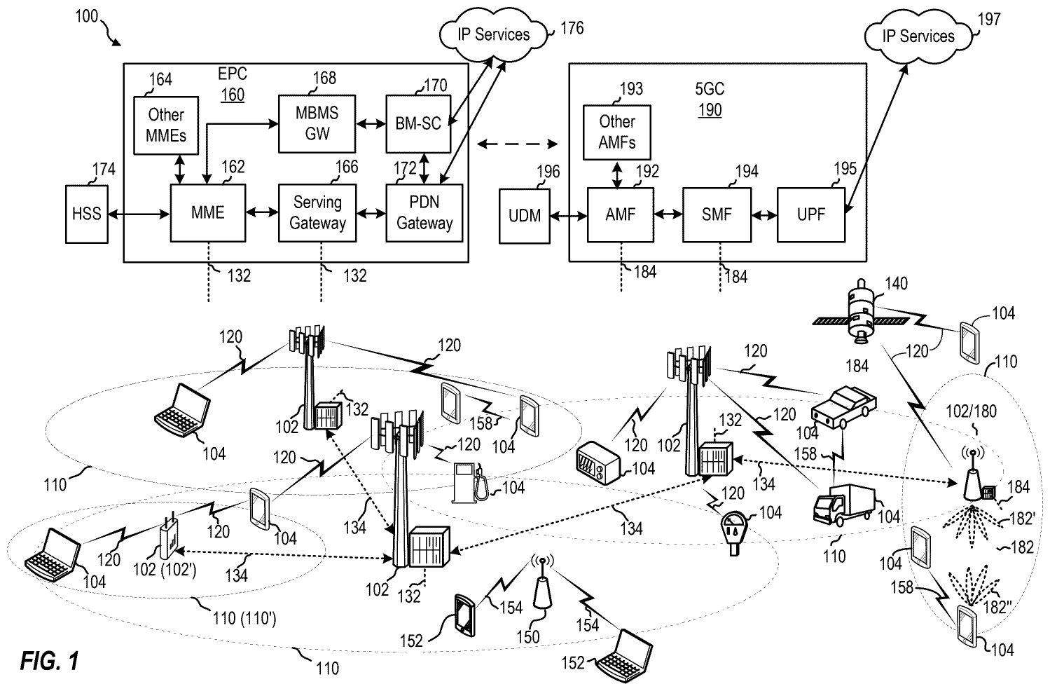

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

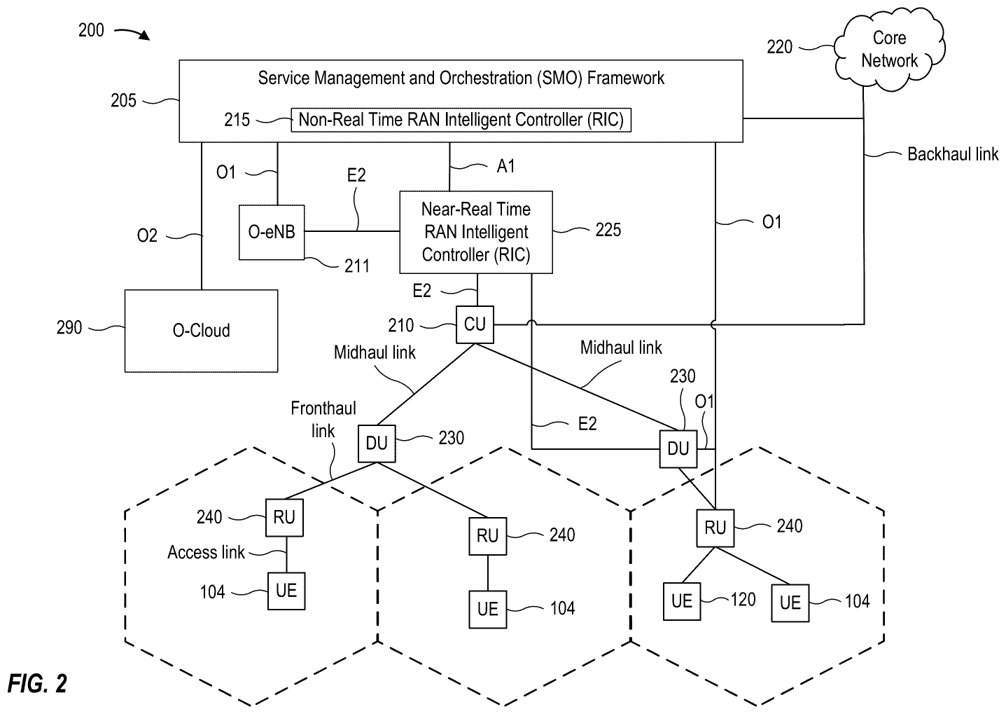

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

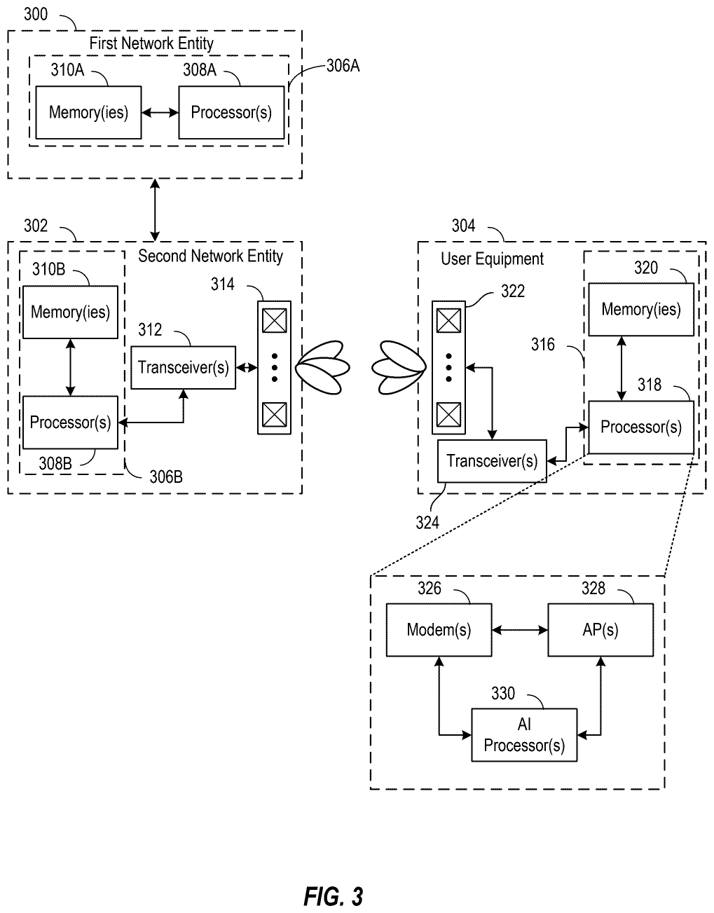

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306A” at first network entity 300 and “processing system 306B” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308A” and “processor(s) 308B”) and one or more memories 310 (illustrated as “memory(ies) 310A” and “memory(ies) 310B”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

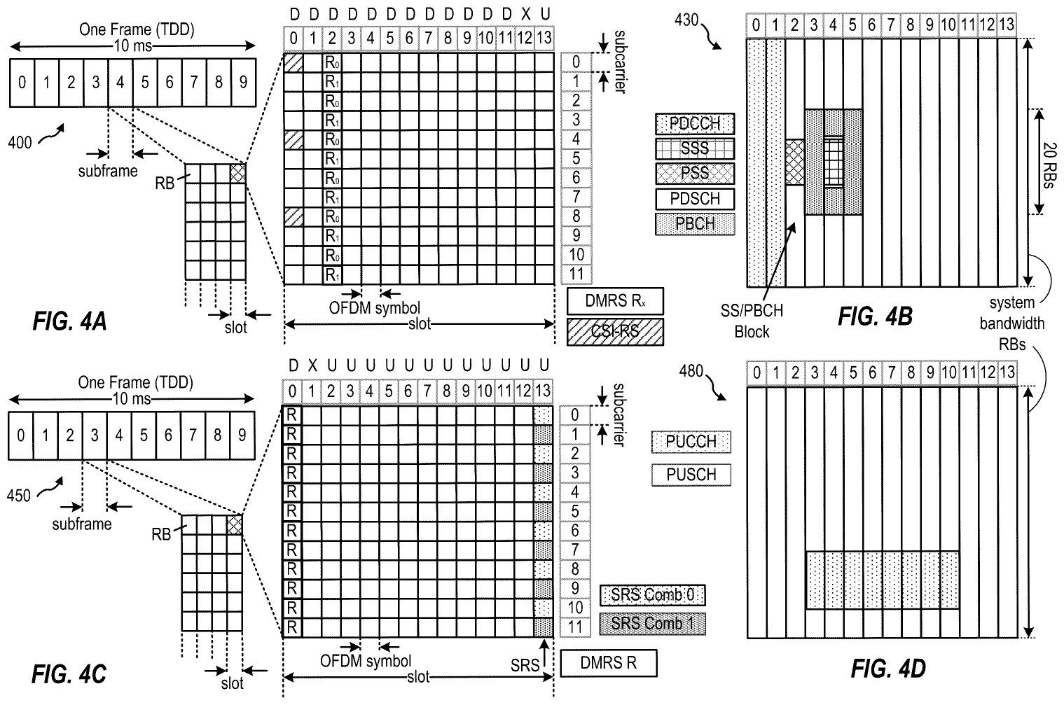

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 μslots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2\hat{ }μ×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Antenna Selection Operations

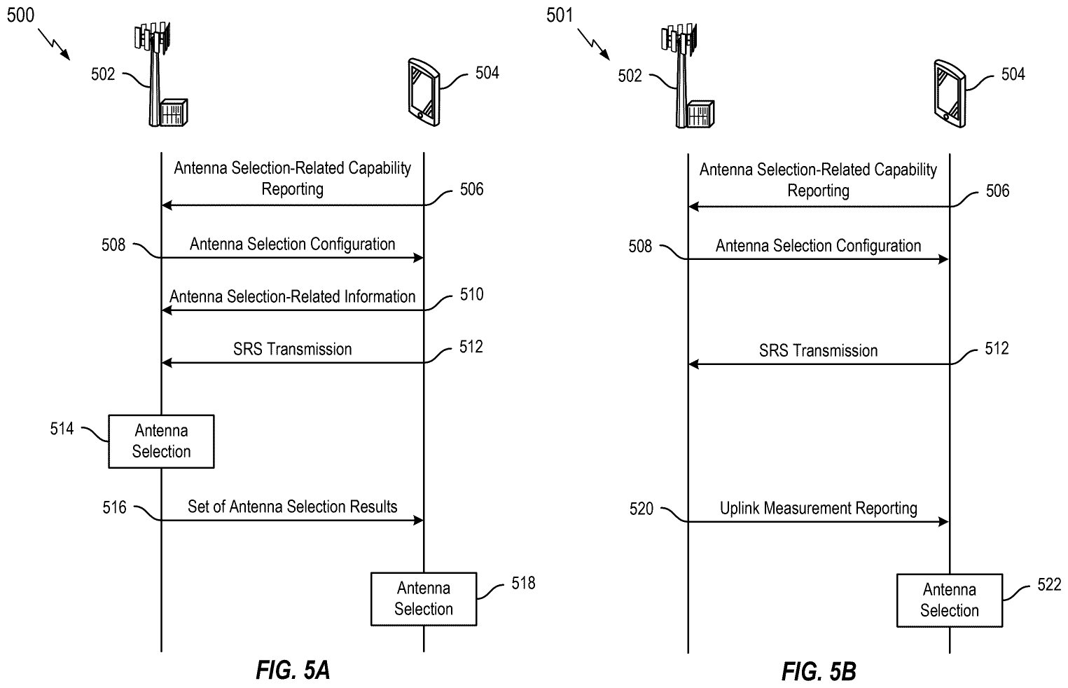

FIGS. 5A and 5B depict example closed-loop antenna selection operations in accordance with aspects of the present disclosure. For example, FIG. 5A depicts a first closed-loop antenna selection operation 500, and FIG. 5B depicts a second closed-loop antenna selection operation 501. In some aspects, the first closed-loop antenna selection operation 500 and the second closed-loop antenna selection operation 501 may implement aspects of or may be implemented by aspects of FIG. 1-4. For example, the first closed-loop antenna selection operation 500 and the second closed-loop antenna selection operation 501 may include a network entity 502 and a UE 504. In some aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of UE 104 depicted and described with respect to FIG. 1 or the UE 304 depicted and described with respect to FIG. 3.

In some aspects, the first closed-loop antenna selection operation 500 and the second closed-loop antenna selection operation 501 may include processes for performing an antenna selection based on SRS(s) transmitted by the UE 504 in accordance with aspects described herein. Additionally, the antenna selection may enable the UE 504 to communicate (e.g., transmit or receive) signals over a selection of antennas and/or corresponding antenna ports or transceiver chains (e.g., transmit chains or receive chains). A chain may refer to a set of electronic components in a radio (e.g., of the UE 504) attached near the antenna for processing received signals and/or transmitted signals and may include one or more power amplifiers, switches, filters, etc. A receive chain may process received signals. A transmit chain may process signals for transmission. Additionally, a chain may be referred to herein as or may include an RF front end and/or a transmit path. In some aspects, the UE 504 may have a smaller number of transmit chains (e.g., a maximum number of baseband layers) than a number of antennas. For example, the UE 504 may perform the antenna selection for a number (p) of transmit chains (C) and a number (q) of antennas (A) (e.g., such that a notation pCqA is used for the UE 504 with the p transmit chains and the q antennas), where the number of transmit chains is less than the number of antennas (e.g., p<q)

Accordingly, in some examples, the extra (unused) antennas may be available for reception purposes (e.g., the UE 504 can have more receive chains employed than transmit chains). If the UE 504 is capable of switching connections from transmit chains to antennas, then the UE 504 may benefit from selecting a best set of antennas to be connected to the chains, depending on a per-antenna transmit power budget, an overall propagation channel from a baseband for the UE 504 to a baseband for the network entity 502, etc.

In some cases, uplink antenna selection may be determined by the UE 504 in an open-loop manner (e.g., that is also transparent to the network entity 502). The UE 504 may determine a set of antennas for uplink communications based on downlink measurements assuming a level of uplink and downlink reciprocity. However, there may be limitations in the open-loop uplink antenna selection due to a mismatch between uplink and downlink on insertion loss, antenna correlation for time division duplexing (TDD) or frequency division duplexing (FDD), propagation channel-related parameters (e.g., for FDD), and/or other wireless channel parameters. When the UE 504 has a larger number of chains and antennas, the impact of such mismatches could be increased. Additionally, the open-loop antenna selection may not work for FDD, supplementary uplink (SUL), and/or a separate uplink reception point other than a downlink transmission point. Accordingly, the first closed-loop antenna selection operation 500 and the second closed-loop antenna selection operation 501 may be implemented to mitigate or lessen the impact of such mismatches.

In the first closed-loop antenna selection operation 500 of FIG. 5A, at 506, the UE 504 may send antenna selection-related capability reporting to the network entity 502. In some aspects, the antenna selection-related capability reporting may include an indication of a number of transmit chains and/or number of antennas supported by the UE 504 (e.g., pCqA). At 508, the network entity 502 may transmit an antenna selection configuration to the UE 504 indicating SRS resources over which the UE 504 can transmit SRS(s) to the network entity 502 for the antenna selection. At 510, the UE 504 may transmit antenna selection-related information to the network entity 502, such as per-antenna power headroom (PHR) or other assistance information that the network entity 502 can use to determine an antenna selection from the transmitted SRSs. At 512, the UE 504 may transmit the SRSs to the network entity 502. At 514, the network entity 502 may measure the SRSs and may determine a set of antenna selection results from the measurements of the SRSs and/or the assistance information (e.g., per-antenna PHR). At 516, the network entity 502 may send the set of antenna selection results to the UE 504. For example, the set of antenna selection results may include a candidate set of selected antennas. At 518, the UE 504 may select a final antenna or set of antennas for uplink communications. In some aspects, the UE 504 may report the selected antenna(s) to the network entity 502.

In the second closed-loop antenna selection operation 501 of FIG. 5B, the UE 504 and the network entity 502 may perform the same operations at 506, 508, and 512 as described with reference to the first closed-loop antenna selection operation 500 of FIG. 5A. However, the UE 504 may not report the antenna selection-related information to the network entity 502, and the network entity 502 may not determine the set of antenna selection results as described with reference to FIG. 5A. Instead, at 520, the network entity 502 may measure the SRSs and may send, to the UE 504, uplink measurement reporting related to the transmitted SRSs. For example, the uplink measurement reporting may include SRS-RSRP measurements, transmit antenna correlation coefficients, etc. At 522, the UE 504 may select an antenna or set of antennas for uplink communications based on the measurement reporting and its own antenna selection-related parameters. In some aspects, the UE 504 may report the selected antenna(s) to the network entity 502.

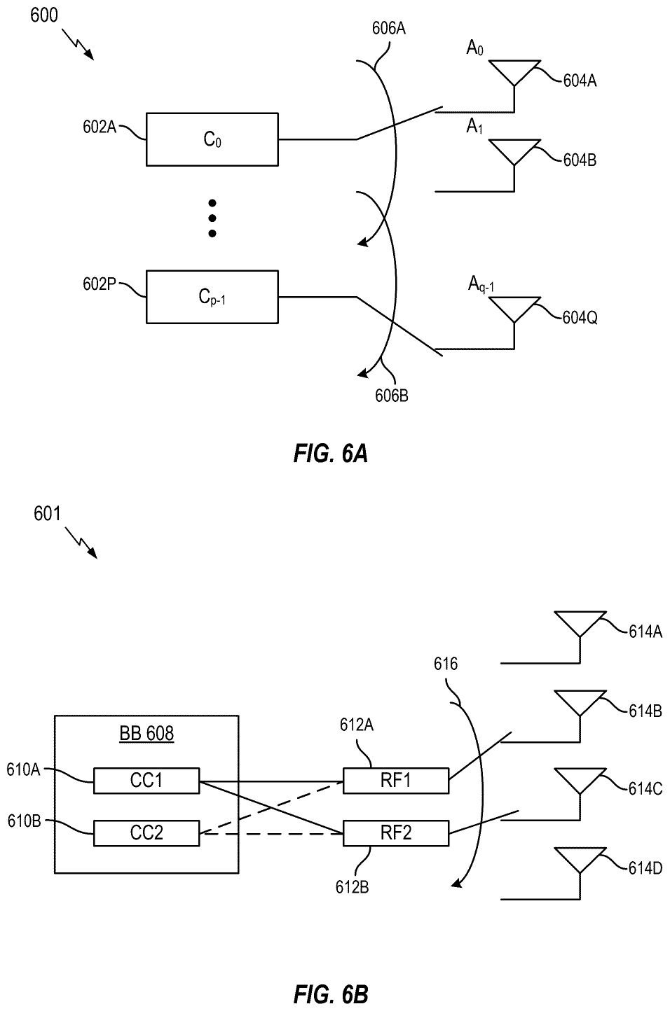

FIGS. 6A and 6B depict example antenna switching operations in accordance with aspects of the present disclosure. For example, FIG. 6A depicts an antenna switching operation 600, and FIG. 6B depicts an antenna switching operation 601. In some aspects, the antenna switching operation 600 and the antenna switching operation 601 may implement aspects of or may be implemented by aspects of FIG. 1-5. For example, a UE may perform the antenna switching operation 600 and/or the antenna switching operation 601 as part of or based on antenna selection results of the first closed-loop antenna selection operation 500 described with reference to FIG. 5A and/or the second closed-loop antenna selection operation 501 described with reference to FIG. 5B.

In some aspects, the UE may include an RF transceiver that has multiple transmit chains (e.g., transmit RF chains, transmit paths, etc.) that can switch among multiple antennas. For example, the UE may include p transmit chains (C) and q antennas (A), denoted by pCqA. Additionally, for uplink, the UE may have a smaller number of transmit chains (e.g., according to a maximum number of baseband layers) than the number of antennas. Accordingly, such extra antennas may be available for reception purposes, such that a higher number of receive chains may be employed than transmit chains for the UE. If the UE is capable of switching connections between the transmit chains and the antennas (e.g., performing antenna switching), communications for the UE may benefit from selecting optimal antennas to be connected to the chains based on a per-antenna transmit power budget and an overall propagation channel from a UE baseband to a baseband for a network entity communicating with the UE.

In the example of the antenna switching operation 600 of FIG. 6A, the UE may include a plurality of transmit chains 602 and a plurality of antennas 604. For example, the UE may include a first transmit chain 602A (e.g., transmit chain C₀) to a p-th transmit chain 602P (e.g., transmit chain Cₚ₋₁. Additionally, the UE may include a first antenna 604A (e.g., antenna A₀), a second antenna 604B (e.g., antenna A₁), etc., up to q-th antenna 604Q (e.g., antenna A_{q-1}).

Accordingly, the UE may be capable of performing a first antenna switching 606A to switch which antenna 604 is connected to the first transmit chain 602A and a second antenna switching 606B to switch antenna 604 is connected to the p-th transmit chain 602P. In some aspects, the UE may perform the first antenna switching 606A and/or the second antenna switching 606B as part of the first closed-loop antenna selection operation 500 and/or the second closed-loop antenna selection operation 501 described with reference to FIGS. 5A and 5B, respectively. For example, the UE may perform the first antenna switching 606A and/or the second antenna switching 606B when sending SRS(s) to a network entity to enable the network entity to perform measurements on the SRS(s) sent via different antennas, such that the network entity can identify which antenna corresponds to higher signal quality and/or higher signal power for subsequent communications for the UE. Additionally or alternatively, the UE may perform the first antenna switching 606A and/or the second antenna switching 606B based on antenna selection results as described with reference to FIGS. 5A and 5B.

In the example of the antenna switching operation 601 of FIG. 6B, a UE may be configured for intra-band CA communications, where multiple CCs 610 are configured in a baseband frequency 608 (e.g., a same frequency band) for the intra-band CA communications. For example, a first CC 610A and a second CC 610B may be configured in the baseband frequency 608 for the intra-band CA communications for the UE. In some aspects, the multiple CCs 610 may be adjacent to each other in the baseband frequency 608 (e.g., intra-band contiguous CA). Additionally or alternatively, the multiple CCs 610 may be in the baseband frequency 608 but may be separated by a gap (e.g., intra-band non-contiguous CA).

Additionally, in some cases, during SRS transmission on a PUSCH-less cell (e.g., secondary cell (SCell)), the UE 504 may temporarily suspend uplink transmissions on a serving cell with PUSCH in a same configured grant to allow SRS transmissions on the PUSCH-less cell. For example, for different CA configurations, the UE may not be expected to be indicated with an SRS transmission from a CC and to be configured or scheduled with a separate uplink transmission from a different CC in the same symbol, where the separate uplink transmission includes a PUSCH, uplink DMRS, uplink phase tracking reference signal (PTRS), and/or physical uplink control channel (PUCCH) transmission. Additionally, the different CA configurations may include an intra-band contiguous CA or, if simultaneous SRS and PUCCH/PUSCH transmissions are not supported by the UE 504, an inter-band CA (e.g., CCs are located on separate frequency bands) or an intra-band non-contiguous CA band combination if simultaneous SRS and PUCCH/PUSCH transmissions are not supported by UE.

In some aspects, for the intra-band CA communications, the UE may use common transmit chains 612 and common antennas 614 to support the multiple CCs 610. In the example of FIG. 6B, the UE may include a first transmit chain 612A (e.g., denoted by RF1) and a second transmit chain 612B (e.g., denoted by RF2). In some aspects, communications on each of the multiple CCs 610 may be sent and/or received via each of the transmit chains 612. For example, communications on the first CC 610A may be sent and/or received via the first transmit chain 612A and the second transmit chain 612B, and communications on the second CC 610B may be sent and/or received via the first transmit chain 612A and the second transmit chain 612B.

Additionally, the UE may include a first antenna 614A, a second antenna 614B, a third antenna 614C, and a fourth antenna 614D. In some aspects, a connection from the transmit chains 612 to the antennas 614 may be common for all of the multiple CCs 610. That is, communications on the first CC 610A and on the second CC 610B using the first transmit chain 612A may occur on a same antenna 614 (e.g., the second antenna 614B), and communications on the first CC 610A and on the second CC 610B using the second transmit chain 612B may occur on a same antenna 614 (e.g., the third antenna 614C).

In some aspects, an antenna selection result may also be the same across all of the multiple CCs 610. For example, an antenna selection result for the first transmit chain 612A (e.g., indicating which antenna 614 should be connected to the first transmit chain 612A) may be the same for the first CC 610A and on the second CC 610B, and an antenna selection result for the second transmit chain 612B (e.g., indicating which antenna 614 should be connected to the second transmit chain 612B) may be the same for the first CC 610A and on the second CC 610B. Additionally, the UE may perform an antenna switching 616 as part of and/or based on antenna selection results from the first closed-loop antenna selection operation 500 and/or the second closed-loop antenna selection operation 501 described with reference to FIGS. 5A and 5B, respectively. For example, the antenna switching 616 may include switching which antenna 614 is connected to each of the transmit chains 612 for all of the multiple CCs 610 as part of and/or based on antenna selection results from an antenna selection operation.

### Aspects Related to Linking CCs for SRS Transmission(s) to Enable a Common Antenna Selection Operation

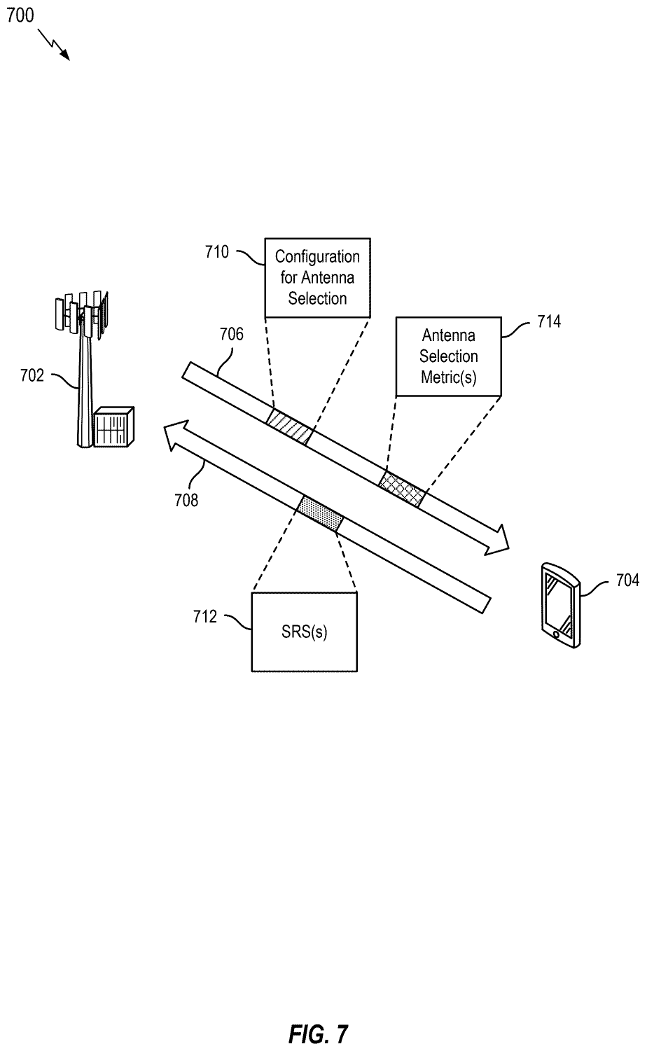

FIG. 7 depicts an example wireless communications network 700 that supports linking CCs for SRS transmission(s) to enable a common antenna selection operation in accordance with aspects of the present disclosure. In some examples, the wireless communications network 700 may implement aspects of or may be implemented by aspects of FIG. 1-6. For example, the wireless communications network 700 may include a network entity 702 and a UE 704. In some aspects, the network entity 702 may be an example of the BS 102 depicted and described with respect to FIG. 1, the first network entity 300 or the second network entity 302 depicted and described with respect to FIG. 3, a disaggregated base station depicted and described with respect to FIG. 2, or the network entity 502 depicted and described with respect to FIG. 5. Similarly, the UE 704 may be an example of UE 104 depicted and described with respect to FIG. 1, the UE 304 depicted and described with respect to FIG. 3, or the UE 504 depicted and described with respect to FIG. 5. Additionally, the wireless communications network 500 may be an example of wireless communications network 100 and may support communication between the network entity 702 and the UE 704. For example, the network entity 702 and the UE 704 may wirelessly communicate via a communication link 706 (e.g., a downlink communication link, one or more carriers, a communication link 120, etc.) and a communication link 708 (e.g., an uplink communication link, one or more carriers, a communication link 120, etc.).

In some aspects, the UE 704 may be configured for CA communications, such that the UE 704 can communicate on multiple CCs corresponding to multiple (serving) cells in a same cell group. For example, based on the CA, communications on the multiple CCs may be aggregated and transmitted in parallel to and/or from the UE 704, thereby allowing for an overall wider bandwidth and correspondingly higher per-link data rates. That is, the UE (e.g., capable of CA) may receive and/or transmit communications simultaneously on the multiple CCs. CA may combine the multiple CCs into a single data channel. One CC may be used as a primary CC (PCC) (e.g., carrying data), and the remaining CC(s) may be used as secondary CCs (SCCs) that provide additional capacity. Additionally, the CA communications may include intra-band CA as described herein. Based on the UE 704 being configured for the CA communications (e.g., intra-band CA), antenna selection results may be common across the multiple CCs.

In accordance with aspects of the present disclosure, the UE 704 may receive a configuration 710 from the network entity (e.g., via the communication link 706) for an antenna selection operation. In some aspects, the configuration 710 may indicate a link between at least two CCs of a plurality of CCs configured for the CA communications. Subsequently, the UE 704 may send a plurality of SRSs 712 to the network entity 702 (e.g., via the communication link 708) via the at least two linked CCs according to the configuration 710. Accordingly, the UE 704 may receive one or more antenna selection metrics 714 from the network entity 702 (e.g., via the communication link 706), where the one or more antenna selection metrics 714 may be derived by the network entity 702 based on measurements of the plurality of SRSs 712. For example, the network entity 702 may jointly measure SRS(s) sent via the at least two linked CCs, and the one or more antenna selection metrics 714 may include per-antenna SRS-RSRPs and/or antenna selection results which are common across the at least two linked CCs.

In some aspects, the network entity 702 may configure (e.g., via the configuration 710) SRS resource sets to be used for a common antenna selection operation across different CCs based on a linkage ID configured to each SRS resource set. For example, each CC of the at least two CCs may include an uplink BWP that has at least one SRS resource set configured with an antenna selection usage as described previously (e.g., the SRS resource set may be referred to as an antenna selection SRS resource set) and may also include a same number of configured SRS resources each with a same number of ports. Additionally, each SRS resource set may be configured with a linkage ID, such that SRS resource sets with a same linkage ID across CCs may be linked to each other. That is, the UE 704 may send the plurality of SRSs 712 on SRS resources with a same resource ID in the SRS resource sets with the same linkage ID using a same port-to-antenna mapping. Additionally, the SRS resources with the same resource ID in the linked SRS resource sets may have same time-domain parameters, such that the plurality of SRSs 712 may be transmitted in same symbols of the at least two linked CCs. For example, the time-domain parameters for SRS resources may be referred to as time-domain SRS parameters and may include time-domain resources (e.g., symbols, slots, etc.) allocated and/or configured for the SRS resources.

For the SRS resource sets, the UE 704 may receive individual configuration messages (e.g., via RRC signaling) for each of the SRS resource sets (e.g., as part of the configuration 710), where each configuration message indicates the SRS resources in each SRS resource set, a usage for the SRS resource set, and a linkage ID. Additionally or alternatively, the UE 704 may receive a single configuration message (e.g., via RRC signaling) for all of the SRS resource sets (e.g., as part of the configuration 710), where the single configuration message indicates the separate configurations for each of the SRS resource sets.

Additionally, the network entity 702 may indicate a CC association to SRS resource set in the configuration 710. For example, which CC is associated to which SRS resource set (or SRS resource) may be explicitly or implicitly configured in RRC. In some aspects, a cross-CC SRS resource set configuration and/or a self SRS resource set configuration may be used to indicate the association between CCs and SRS resource sets. The cross-CC SRS resource set configuration may be used when a configuring CC and a configured CC are different. For example, RRC signaling transmitted in a first CC (e.g., CC1) may configure an SRS resource set for a second CC (e.g., CC2). In this case, an explicit CC index may be configured together with an SRS resource set configuration. Additionally or alternatively, the self SRS resource set configuration may be used when a configuring CC is the same as a configured CC. For example, RRC signaling transmitted in the first CC may configure an SRS resource set for the first CC. In this case, the network entity may omit an explicit CC index, such that if there is no explicit CC index included in the RRC signaling, then the UE 704 may implicitly assume the self SRS resource set configuration.

In some aspects, rather than configuring a linkage ID to SRS resource sets, the network entity may configure the common antenna selection operation across different CCs based on a CC group configuration (e.g., as part of the configuration 710). For example, the network entity 702 may configure one or more CC groups (e.g., referred to as antenna selection CC group(s)), where a CC group includes one or more CCs for applying the common antenna selection operation. That is, the at least two CCs may be linked based on being part of a same CC group. In some aspects, the network entity 702 may configure the one or more CC groups via RRC signaling with a list of CC indices to indicate which CC(s) belong to a corresponding CC group. Accordingly, each CC within a CC group may include an uplink BWP that has at least one SRS resource set that includes a same number of SRS resources each with a same number of ports.

Subsequently, the UE 704 may determine a linkage between SRS resource sets across CCs within a CC group based on a set ID configured for each SRS resource set. For example, the UE 704 may determine that SRS resource sets with a same set ID have linkage to each other. That is, the UE 704 may send the plurality of SRSs 712 on SRS resources with a same resource ID in the SRS resource sets with the same set ID within a CC group with a same port-to-antenna mapping. Additionally, the SRS resources with the same resource ID in the linked SRS resource sets may have same time-domain parameters, such that the plurality of SRSs 712 may be transmitted in same symbols of the CCs in the CC group.

In some aspects, rather than configuring a linkage ID to SRS resource sets and/or configuring the CC group(s), the network entity 702 may configure (e.g., as part of the configuration 710) a common antenna selection operation across different CCs when SRS symbol timing is aligned. For example, each CC may include an uplink BWP that has at least one configured SRS resource set with an antenna selection usage and includes a same number of SRS resources each with a same number of ports. Accordingly, when SRS resources in SRS resource sets of different CCs have a same time-domain resource configuration, the UE 704 may determine such SRS resources are linked to each other. Subsequently, the UE 704 may send the plurality of SRSs 712 via the different SRS resources with the same time-domain parameters in different CCs with a same port-to-antenna mapping.

For the port-to-antenna mapping described herein, the UE 704 may transmit the plurality of SRSs 712 to the network entity 702 via the communication link 708 and may precode the plurality of SRSs 712 using a computed uplink precoder. In some aspects, each SRS may be a single-port SRS, meaning each SRS is transmitted by the UE 704 on a separate SRS port. For example, the UE 704 may send an SRS via one or more hypothetical layers (e.g., of a potential uplink transmission) corresponding to one or more SRS ports. In some aspects, each SRS port may correspond to a specific MIMO layer, where each MIMO layer may correspond to a different data stream of traffic communicated via spatial multiplexing. In certain aspects, an SRS port may correspond to a layer, while an antenna port refers to a physical or virtual antenna element that is used to transmit or receive a signal. In a multi-antenna system, multiple antenna ports may be used to transmit or receive signals simultaneously. A given SRS port may be associated with and/or mapped to a specific antenna port or a group of antenna ports. Further, a single-port communication, such as a single-port SRS, may be communicated via a single layer, such as a single SRS port. Additionally or alternatively, a multi-port communication, such as a multi-port SRS, may be communicated via multiple layers, such as multiple SRS ports.

In some cases, multiple SRS ports may be used to transmit the plurality of SRSs 712 (e.g., single port SRSs) from different antenna ports, allowing the network entity 702 to estimate the channel state from multiple angles or directions. This may be useful in scenarios where the UE has multiple antenna panels or arrays, and needs to perform beamforming, such as to maximize the signal strength and/or minimize interference.

Accordingly, to determine the one or more antenna selection metrics 714, the network entity 702 may measure the plurality of SRSs 712 to determine channel estimates of an uplink channel and/or a downlink channel between the network entity 702 and the UE 704. For example, the network entity may determine which SRS(s) are measured with suitable (e.g., highest, above a threshold, etc.) channel estimates and may indicate the SRS(s) measured with suitable channel estimates and/or measurements of the SRS(s) (e.g., SRS-RSRP measurements) to the UE 704. For example, the network entity may include an SRS resource indicator (SRI) via the one or more antenna selection metrics 714 to indicate the SRS(s), such as by an index value, and/or corresponding antennas used to send the SRS(s). In some aspects, the UE 704 may subsequently communicate with the network entity 702 based on the one or more antenna selection metrics 714. For example, the UE 704 may perform an antenna switching (e.g., as described with reference to FIGS. 6A and 6B) and/or may utilize a precoder for the subsequent communications, where each layer corresponds to a precoder derived according to the one or more antenna selection metrics 714.

In some aspects, to enable the common antenna selection operation described herein, the UE 704 may report UE capability information to the network entity 702. For example, the UE capability information may include a number of separate antenna selection operations supported by the UE 704 for each frequency band combination. For example, if a same RF and/or same transmit chain is used for CA in a certain band combination, a number of separate antenna selection operations supported by the UE 704 may equal one. Additionally or alternatively, if separate RFs and/or separate transmit chains can be used for CA in a certain band combination, a number of separate antenna selection operations supported by the UE 704 may be equal to N (e.g., corresponding to the number of separate RFs and/or separate transmit chains).

Additionally or alternatively, the UE capability information may include a number of transmit chains configured for the UE 704 (e.g., corresponding to a number of maximum layers supported by the UE 704) and a number of antennas of the UE 704 (e.g., corresponding to a number of ports configured for the UE 704) for each separate antenna selection operation. For example, when the number of separate antenna selection operations for CA supported by the UE 704 is equal to one, then a number of transmit chains configured for the UE 704 may be denoted as X1 and a number of antennas of the UE 704 may be denoted as Y1. Additionally or alternatively, when the number of separate antenna selection operations for CA supported by the UE 704 is equal to two, then a number of transmit chains configured for the UE 704 may be denoted as X1 and a number of antennas of the UE 704 may be denoted as Y1 for the first antenna selection operation and a number of transmit chains configured for the UE 704 may be denoted as X2 and a number of antennas of the UE 704 may be denoted as Y2 for the second antenna selection operation.

In some aspects, an aperiodic SRS triggering bit in an uplink grant may indicate an SRS resource set which is configured with a common antenna selection operation as described previously (e.g., using a linkage ID, a CC group, and/or SRS resources with an aligned SRS symbol timing). For example, the network entity 702 may send the uplink grant to the UE 704, and the uplink grant may include an SRS request field that indicates the SRS resource set. Accordingly, the UE 704 may send the plurality of SRSs 712 via the SRS resource set indicated in the uplink grant in a first CC and via an additional SRS resource set in a second CC, where the additional SRS resource set is linked to the SRS resource set indicated in the uplink grant and/or the first CC and the second CC are linked based on the techniques described herein. Additionally, the UE 704 may simultaneously send the plurality of SRSs 712 via the linked SRS resource sets and/or across the linked CCs in a same slot as triggered in the uplink grant.

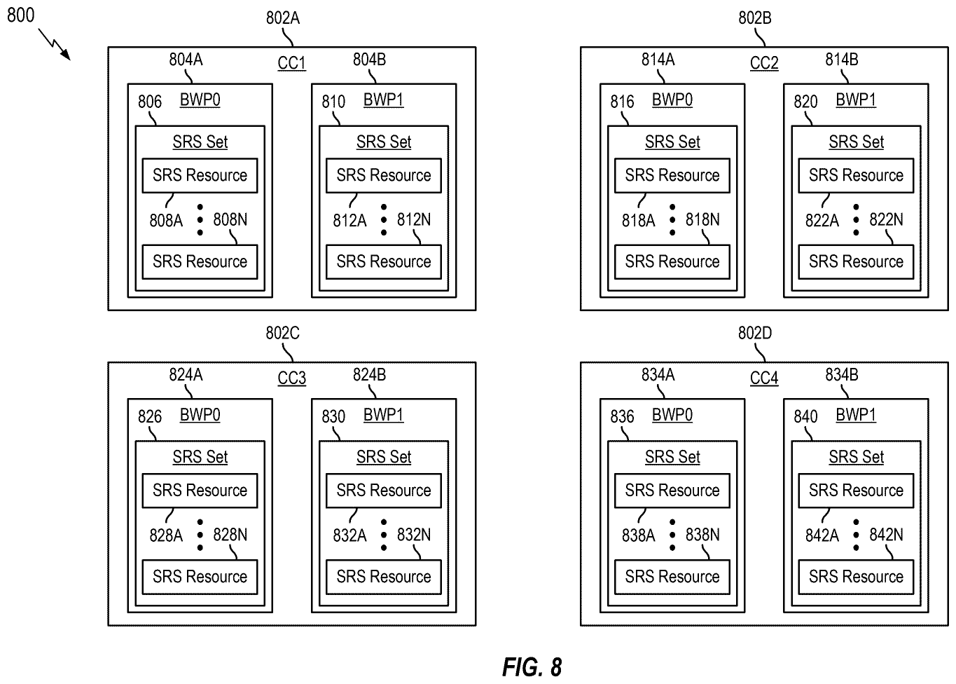

FIG. 8 depicts an example linkage 800 between CCs for a common antenna selection operation in accordance with aspects of the present disclosure. In some aspects, the linkage 800 may implement aspects of or may be implemented by aspects of FIGS. 1-7. For example, a UE may determine and/or use the linkage 800 to send a plurality of SRSs via at least two CCs that are linked based on a configuration for an antenna selection operation as described with reference to FIG. 7. In the example of FIG. 8, the UE may be configured with at least four CCs 802, such as a first CC 802A (e.g., CC1), a second CC 802B (e.g., CC2), a third CC 802C (e.g., CC3), and a fourth CC 802D (e.g., CC4). In some aspects, the four CCs 802 may be located in a same frequency band (e.g., for intra-band CA).

When the UE is configured with multiple CCs 802, each CC 802 may include multiple BWPs. For example, the first CC 802A may include a first BWP 804A (e.g., BWP0) and a second BWP 804B (e.g., BWP1), the second CC 802B may include a first BWP 814A (e.g., BWP0) and a second BWP 814B (e.g., BWP1), the third CC 802C may include a first BWP 824A (e.g., BWP0) and a second BWP 824B (e.g., BWP1), and the fourth CC 802D may include a first BWP 834A (e.g., BWP0) and a second BWP 834B (e.g., BWP1). While two BWPs are shown in each CC 802 in the example of FIG. 8, each CC 802 may include fewer or more BWPs than two. In some aspects, a single BWP may be active per CC 802 in a single slot.

In some aspects, each SRS resource configuration (e.g., SRS-Resource configuration) may be associated with a single downlink BWP, and each SRS resource configuration may include a number of antenna ports, a number of hops, a number of consecutive OFDM symbols, a time-domain starting position, a frequency-domain starting position, and/or the like, configured for each SRS resource. In certain aspects, each SRS resource set configuration (e.g., SRS-ResourceSet configuration) may be associated with a single downlink BWP, and each SRS resource set configuration may include SRS resources, a usage (e.g., beam management, antenna switching, codebook, or non-codebook), and/or the like, configured for each SRS resource set.

For example, the first BWP 804A of the first CC 802A may include a first SRS resource set 806 that includes a plurality of SRS resources 808 (e.g., from a first SRS resource 808A to an n-th SRS resource 808N), and the second BWP 804B of the first CC 802A may include a second SRS resource set 810 that includes a plurality of SRS resources 812 (e.g., from a first SRS resource 812A to an n-th SRS resource 812N). The first BWP 814A of the second CC 802B may include a first SRS resource set 816 that includes a plurality of SRS resources 818 (e.g., from a first SRS resource 818A to an n-th SRS resource 818N), and the second BWP 814B of the second CC 802B may include a second SRS resource set 820 that includes a plurality of SRS resources 822 (e.g., from a first SRS resource 822A to an n-th SRS resource 822N).

The first BWP 824A of the third CC 802C may include a first SRS resource set 826 that includes a plurality of SRS resources 828 (e.g., from a first SRS resource 828A to an n-th SRS resource 828N), and the second BWP 824B of the third CC 802C may include a second SRS resource set 830 that includes a plurality of SRS resources 832 (e.g., from a first SRS resource 832A to an n-th SRS resource 832N). The first BWP 834A of the fourth CC 802D may include a first SRS resource set 836 that includes a plurality of SRS resources 838 (e.g., from a first SRS resource 838A to an n-th SRS resource 838N), and the second BWP 834B of the fourth CC 802D may include a second SRS resource set 840 that includes a plurality of SRS resources 842 (e.g., from a first SRS resource 842A to an n-th SRS resource 842N). In some aspects, each SRS resource set may be referred to as an SRS set. Additionally, SRS resources for different CCs 802 may be separate SRS resources. For example, the first SRS resource 812A of the second SRS resource set 810 in the first CC 802A may be different than the first SRS resource 822A of the second SRS resource set 820 in the second CC 802B.

Without the linkage between CCs described herein, when the UE is configured with multiple CCs, SRS transmission may be performed in a per-CC manner, such that the network entity performs measurements and/or determines antenna selection results in a per-CC manner. Accordingly, the network entity may configure a linkage between CCs (e.g., based on the configuration 710 as described with reference to FIG. 7) based on configuring a linkage ID for SRS resource sets in each CC, configuring one or more CC groups, and/or SRS resources with an aligned SRS symbol timing.

For the linkage ID option, the network entity may configure at least one SRS resource set in each CC 802 (e.g., in a corresponding BWP) with a linkage ID. For example, the network entity may configure the second SRS resource set 810 of the second BWP 804B in the first CC 802A with a linkage ID of ‘1,’ the second SRS resource set 820 of the second BWP 814B in the second CC 802B with a linkage ID of ‘1,’ the second SRS resource set 830 of the second BWP 824B in the third CC 802C with a linkage ID of ‘2,’ and the second SRS resource set 840 of the second BWP 834B in the fourth CC 802D with a linkage ID of ‘2.’

Subsequently, the UE may apply a same port-to-antenna mapping for the plurality of SRS resources 812 configured for the second SRS resource set 810 in the first CC 802A and for the plurality of SRS resources 822 configured for the second SRS resource set 820 in the second CC 802B based on the second SRS resource set 810 and the second SRS resource set 820 having the same linkage ID (e.g., ‘1’). Additionally, the UE may apply a same port-to-antenna mapping for the plurality of SRS resources 832 configured for the second SRS resource set 830 in the third CC 802C and for the plurality of SRS resources 842 configured for the second SRS resource set 840 in the fourth CC 802D based on the second SRS resource set 830 and the second SRS resource set 840 having the same linkage ID (e.g., ‘2’). In some aspects, the first CC 802A and the second CC 802B may be considered linked based on the second SRS resource set 810 and the second SRS resource set 820 having the same linkage ID (e.g., ‘1’), and the third CC 802C and the fourth CC 802D may be considered linked based on the second SRS resource set 830 and the second SRS resource set 840 having the same linkage ID (e.g., ‘2’).

Additionally or alternatively, for the CC group option and as an example, the network entity may configure (e.g., semi-statically, such as via RRC signaling) a first CC group and a second CC group. For example, the first CC group may include the first CC 802A and the second CC 802B, and the second CC group may include the third CC 802C and the fourth CC 802D. In some aspects, the network entity may configure the second SRS resource set 810 in the second BWP 804B of the first CC 802A with an SRS resource set ID of ‘1,’ the second SRS resource set 820 in the second BWP 814B of the second CC 802B with an SRS resource set ID of ‘1,’ the second SRS resource set 830 in the second BWP 824B of the third CC 802C with an SRS resource set ID of ‘1,’ and the second SRS resource set 840 in the second BWP 834B of the fourth CC 802D with an SRS resource set ID of ‘1.’

Accordingly, the UE may apply a same port-to-antenna mapping for the plurality of SRS resources 812 configured for the second SRS resource set 810 in the first CC 802A and for the plurality of SRS resources 822 configured for the second SRS resource set 820 in the second CC 802B based on the first CC 802A and the second CC 802B being configured for the first CC group. Additionally, the UE may apply a same port-to-antenna mapping for the plurality of SRS resources 832 configured for the second SRS resource set 830 in the third CC 802C and for the plurality of SRS resources 842 configured for the second SRS resource set 840 in the fourth CC 802D based on the third CC 802C and the fourth CC 802D being configured for the second CC group. In some aspects, the first CC 802A and the second CC 802B may be considered linked based on being configured for the first CC group, and the third CC 802C and the fourth CC 802D may be considered linked based on being configured for the second CC group. Additionally, a linkage between the SRS resource sets across the CCs 802 within a CC group may be determined based on the SRS resource set ID configured for each SRS resource set. That is, SRS resource sets with the same set ID in a CC group may have linkage to each other.

Additionally or alternatively, for the option where SRS resources with an aligned SRS symbol timing and as an example, the network entity may configure time-domain SRS parameters for the plurality of SRS resources 812 of the second SRS resource set 810 in the first CC 802A and for the plurality of SRS resources 822 of the second SRS resource set 820 in the second CC 802B to be the same. For example, the plurality of SRS resources 812 and the plurality of SRS resources 822 may be configured on same time-domain resources (e.g., symbols, slots, etc.) in the first CC 802A and the second CC 802B, respectively. Additionally, the network entity may configure time-domain SRS parameters for the plurality of SRS resources 832 of the second SRS resource set 830 in the third CC 802C and for the plurality of SRS resources 842 of the second SRS resource set 840 in the fourth CC 802D to be the same. For example, the plurality of SRS resources 832 and the plurality of SRS resources 842 may be configured on same time-domain resources (e.g., symbols, slots, etc.) in the third CC 802C and the fourth CC 802D, respectively.

Accordingly, the UE may apply a same port-to-antenna mapping in a same symbol for the plurality of SRS resources 812 configured for the second SRS resource set 810 in the first CC 802A and for the plurality of SRS resources 822 configured for the second SRS resource set 820 in the second CC 802B based on the time-domain SRS parameters for the plurality of SRS resources 812 and for the plurality of SRS resources 822 being the same. Additionally, the UE may apply a same port-to-antenna mapping in a same symbol for the plurality of SRS resources 832 configured for the second SRS resource set 830 in the third CC 802C and for the plurality of SRS resources 842 configured for the second SRS resource set 840 in the fourth CC 802D based on the time-domain SRS parameters for the plurality of SRS resources 832 and for the plurality of SRS resources 842 being the same. In some aspects, the first CC 802A and the second CC 802B may be considered linked based on the plurality of SRS resources 812 and for the plurality of SRS resources 822 having the same time-domain SRS parameters, and the third CC 802C and the fourth CC 802D may be considered linked based on the plurality of SRS resources 832 and the plurality of SRS resources 842 having the same time-domain SRS parameters.

In some aspects, the UE may send SRSs via the plurality of SRS resources 812 and the plurality of SRS resources 822 using same antenna(s) based on the UE applying the same port-to-antenna mapping for the plurality of SRS resources 812 and the plurality of SRS resources 822. Additionally, the UE may send SRSs via the plurality of SRS resources 832 and the plurality of SRS resources 842 using same antenna(s) based on the UE applying the same port-to-antenna mapping for the plurality of SRS resources 832 and the plurality of SRS resources 842.

In some aspects, each second SRS resource set may be configured with an antenna selection usage. Additionally, a quantity of the plurality of SRS resources 812 configured for the second SRS resource set 810 may be the same as a quantity of the plurality of SRS resources 822 configured for the second SRS resource set 820, and a quantity of the plurality SRS resources 832 configured for the second SRS resource set 830 may be the same as a quantity of the plurality of SRS resources 842 configured for the second SRS resource set 840. Accordingly, the linkage between the first CC 802A and the second CC 802B may also be determined based on each second SRS resource set being configured with the antenna selection usage and the quantity of the plurality of SRS resources 812 being the same as the quantity of the plurality of SRS resources 822. Additionally, the linkage between the third CC 802C and the fourth CC 802D may also be determined based on each second SRS resource set being configured with the antenna selection usage and the quantity of the plurality of SRS resources 832 being the same as the quantity of the plurality of SRS resources 842.

Additionally, in the above described examples, each second BWP of each CC 802 may be considered an active BWP. However, the active BWP may differ between the CCs 802, such that SRS resource sets may be determined linked in whichever BWP is active and the above described options.

### Example Signaling for Linking CCs for SRS Transmission(s) to Enable a Common Antenna Selection Operation

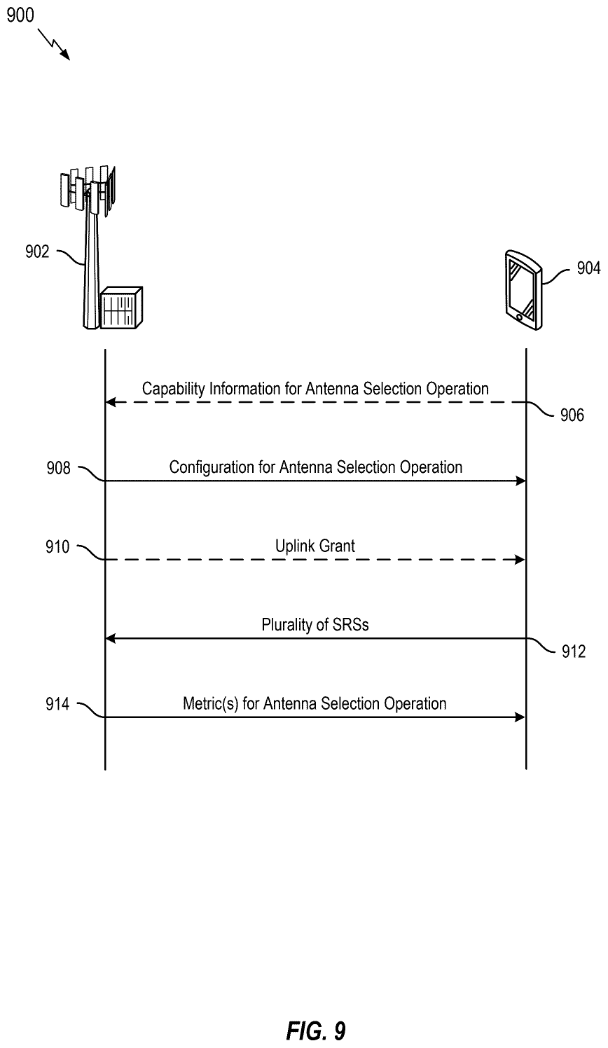

FIG. 9 depicts a process flow 900 for communications in a wireless communications network between a network entity 902 and a UE 904 to enable linking CCs for SRS transmission(s) for a common antenna selection operation in accordance with aspects of the present disclosure. In some aspects, the network entity 902 may be an example of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIG. 5, or the network entity 702 depicted and described with respect to FIG. 7. Similarly, the UE 904 may be an example of UE 104 depicted and described with respect to FIG. 1, the UE 304 depicted and described with respect to FIG. 3, the UE 504 depicted and described with respect to FIG. 5, or the UE 704 depicted and described with respect to FIG. 7. However, in other aspects, UE 904 may be another type of wireless communications device, and network entity 902 may be another type of network entity or network node, such as those described herein. Note that any operations or signaling illustrated with dashed lines may indicate that that operation or signaling is an optional or alternative example.

At 906, the UE 904 may send and the network entity 902 may receive (e.g., obtain) capability information (e.g., UE capability information) for the antenna selection operation. In some aspects, the capability information comprises a number of separate antenna selection operations supported for CA in a frequency band or a frequency band combination, a number of transmit chains and a number of antennas supported for each antenna selection operation, or both.

At 908, the network entity 902 sends and the UE 904 receives (e.g., obtains) a configuration for an antenna selection operation (e.g., the configuration 710 as described with reference to FIG. 7). In some aspects, the configuration may indicate a link between at least two CCs of a plurality of CCs.

In some aspects, the network entity 902 may send and the UE 904 may receive (e.g., obtain) one or more SRS resource set configuration messages indicating a plurality of SRS resource sets and a respective linkage ID for each of the plurality of SRS resource sets. Accordingly, each of the plurality of SRS resource sets may be associated with a respective CC of the plurality of CCs, and the at least two CCs may be linked based at on each CC of the at least two CCs being associated with a same linkage identifier associated with a respective SRS resource set of the CC. In some aspects, for each of the at least two CCs, the CC may be associated with a respective SRS resource set based on being associated with an antenna selection usage parameter, having a same number of SRS resources, having a same number of configured ports, and including SRS resources that have same resource IDs and same time-domain parameters.

Additionally or alternatively, the network entity 902 may send and the UE 904 may receive (e.g., obtain) one or more configurations of one or more CC groups, and the at least two CCs may be linked based on being part of a same CC group. Additionally, each CC of a CC group may be associated with a respective SRS resource set that includes a same number of SRS resources, a same number of configured ports, a same SRS resource set ID, and SRS resources having same resource identifiers and same time-domain parameters.

Additionally or alternatively, the network entity 902 may send and the UE 904 may receive (e.g., obtain) one or more SRS resource set configuration messages indicating a plurality of SRS resource sets, where each of the plurality of SRS resource sets is associated with a respective CC of the plurality of CCs and each of the plurality of SRS resource sets includes a respective one or more SRS resources corresponding to a respective time-domain resource configuration. Accordingly, the at least two CCs may be linked based on each of the at least two CCs being associated with a respective SRS resource set including a respective one or more SRS resources having the same time-domain resource configuration.

At 910, the network entity 902 may send and the UE 904 may receive (e.g., obtain) an uplink grant that includes a triggering bit indicating for the UE 904 to send a plurality of SRSs for the antenna selection operation. In some aspects, the triggering bit may include an indication of a respective SRS resource set associated with each CC of the at least two CCs.

At 912, the UE 904 sends and the network entity receives (e.g., obtains) the plurality of SRSs (e.g., the plurality of SRSs 712 as described with reference to FIG. 7) via the at least two CCs according to the configuration communicated at 908. In some aspects, the UE 904 may send the plurality of SRSs via the at least two CCs via a same antenna. For example, the UE 904 may apply a same port-to-antenna mapping for transmission of the plurality of SRSs via the at least two CCs with a same linkage ID. Additionally or alternatively, the UE 904 may apply a same port-to-antenna mapping for transmission of the plurality of SRSs via the at least two CCs in the same CC group. Additionally or alternatively, the UE 904 may apply a same port-to-antenna mapping for transmission of the plurality of SRSs in a same symbol via the at least two CCs based on each of the at least two CCs being associated with a respective SRS resource set including a respective one or more SRS resources comprising the same time-domain resource configuration.

In some aspects, the UE 904 may send the plurality of SRSs via the at least two CCs based on the respective SRS resource set associated with each CC of the at least two CCs from the indication in the trigger message. Additionally, the UE 904 may send the plurality of SRSs via the at least two CCs in a same slot indicated by the uplink grant.

At 914, the network entity 902 sends and the UE 904 receives (e.g., obtains) one or more metrics for the antenna selection operation (e.g., one or more antenna selection metrics 714 as described with reference to FIG. 7). For example, the one or more metrics may include per-antenna SRS-RSRP measurements, antenna selection results common across the at least two CCs, or a combination thereof. In some aspects, the one or more metrics may be associated with the plurality of SRSs. For example, the network entity 902 may derive the one or more metrics based on measurements of the plurality of SRSs.

Note that the process 900 flow illustrated in FIG. 9 is an example of an antenna selection operation, and aspects of the present disclosure may be applied to linking CCs for SRS transmission(s) for the common antenna selection operation. Note that the process flow 900 illustrated in FIG. 9 is described herein to facilitate an understanding of linking CCs for SRS transmission(s) for the common antenna selection operation, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a User Equipment

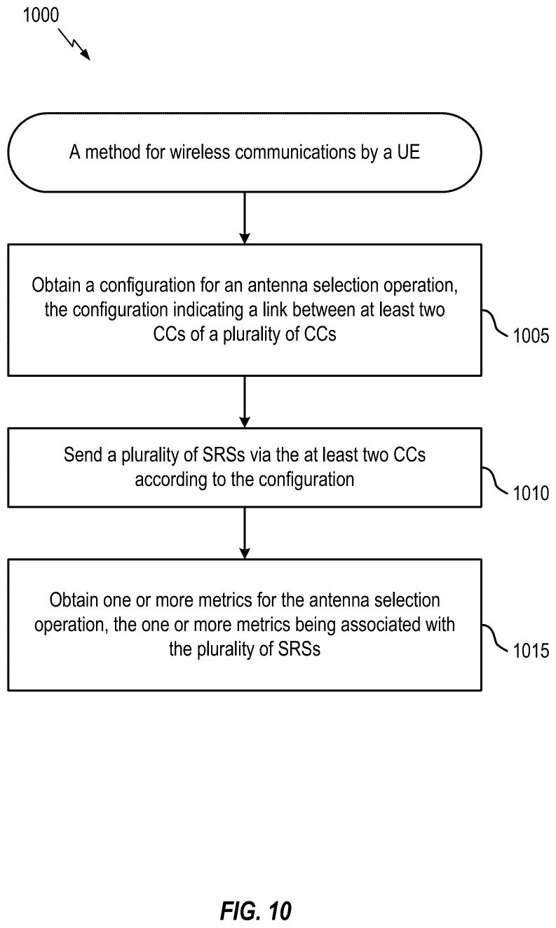

FIG. 10 shows a method 1000 for wireless communications by an apparatus, such as UE 104 of FIG. 1 or UE 304 of FIG. 3.

Method 1000 begins at block 1005 with obtaining a configuration for an antenna selection operation, the configuration indicating a link between at least two CCs of a plurality of CCs.

Method 1000 then proceeds to block 1010 with sending a plurality of SRSs via the at least two CCs according to the configuration.

Method 1000 then proceeds to block 1015 with obtaining one or more metrics for the antenna selection operation, the one or more metrics being associated with the plurality of SRSs.

In some aspects, block 1005 includes obtaining one or more SRS resource set configuration messages indicating a plurality of SRS resource sets and a respective linkage identifier for each of the plurality of SRS resource sets, each of the plurality of SRS resource sets is associated with a respective CC of the plurality of CCs, and the at least two CCs are linked based at least in part on each CC of the at least two CCs being associated with a same linkage identifier associated with a respective SRS resource set of the CC.

In some aspects, block 1010 includes applying a same port-to-antenna mapping for transmission of the plurality of SRSs via the at least two CCs.

In some aspects, for each of the at least two CCs, the CC is associated with a respective SRS resource set: associated with an antenna selection usage parameter, a same number of SRS resources, and a same number of configured ports; and comprising SRS resources having same resource identifiers and same time-domain parameters.

In some aspects, block 1005 includes obtaining one or more configurations of one or more CC groups, and the at least two CCs are linked based at least in part on being part of a same CC group.

In some aspects, block 1010 includes applying a same port-to-antenna mapping for transmission of the plurality of SRSs via the at least two CCs in the same CC group.

In some aspects, each CC of a CC group is associated with a respective SRS resource set: comprising a same number of SRS resources, a same number of configured ports, and a same SRS resource set identifier, and comprising SRS resources having same resource identifiers and same time-domain parameters.

In some aspects, block 1005 includes obtaining one or more SRS resource set configuration messages indicating a plurality of SRS resource sets, wherein each of the plurality of SRS resource sets is associated with a respective CC of the plurality of CCs, each of the plurality of SRS resource sets comprises a respective one or more SRS resources corresponding to a respective time-domain resource configuration, and the at least two CCs are linked based at least in part on each of the at least two CCs being associated with a respective SRS resource set comprising a respective one or more SRS resources comprising the same time-domain resource configuration.

In some aspects, block 1010 includes applying a same port-to-antenna mapping for transmission of the plurality of SRSs in a same symbol via the at least two CCs.

In some aspects, method 1000 further includes sending capability information for the antenna selection operation.

In some aspects, the capability information comprises a number of separate antenna selection operations supported for carrier aggregation in a frequency band or a frequency band combination, a number of transmit chains and a number of antennas supported for each antenna selection operation, or both.

In some aspects, method 1000 further includes obtaining an uplink grant comprising a triggering bit indicating for the UE to send the plurality of SRSs for the antenna selection operation.

In some aspects, the triggering bit comprises an indication of a respective SRS resource set associated with each CC of the at least two CCs, and block 1010 includes sending the plurality of SRSs via the at least two CCs based at least in part on the respective SRS resource set associated with each CC of the at least two CCs.

In some aspects, block 1010 includes sending the plurality of SRSs via the at least two CCs in a same slot indicated by the uplink grant.

In some aspects, the one or more metrics comprise per-antenna SRS-reference signal received power measurements, antenna selection results common across the at least two CCs, or a combination thereof.

In some aspects, block 1010 includes sending the plurality of SRSs via the at least two CCs via a same antenna.

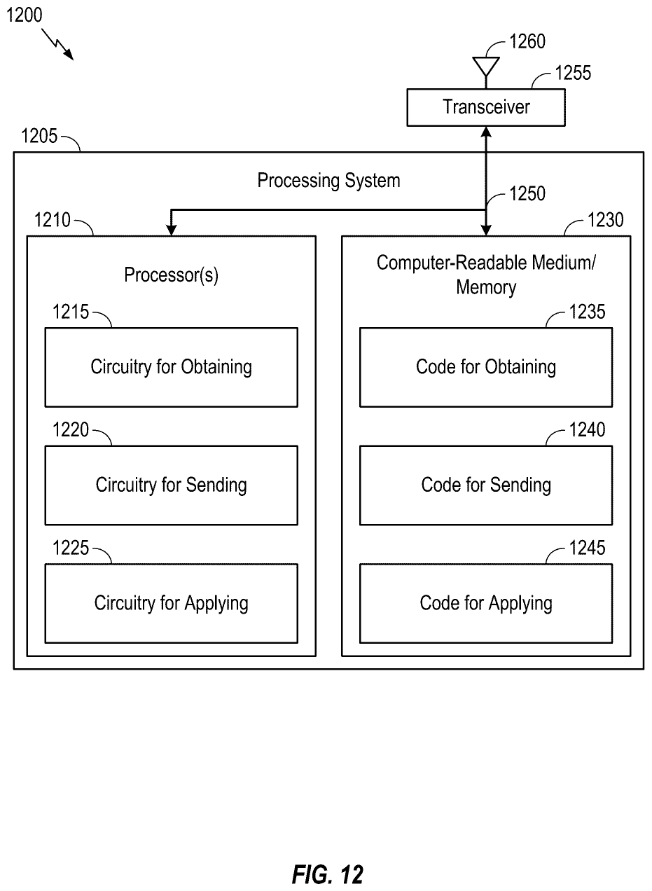

In some aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, based on method 1000, the techniques for linking CCs for SRS transmission(s) for a common antenna selection operation may reduce signaling overhead by enabling a network entity to send common antenna selection results (e.g., via the one or more metrics for the antenna selection operation) across multiple CCs rather than individual antenna selection results per-CC based on performing measurements of the SRS transmission(s) across the linked CCs rather than individually performing measurements of SRS transmission(s) on each CC. Additionally, a computational complexity at the apparatus may be reduced by the apparatus receiving the common antenna selection results across the multiple CCs rather than the individual antenna selection results per-CC and not performing post-processing of the individual antenna selection results to derive the common antenna selection result. In some aspects, the reduced computational complexity may also reduce power consumption at the apparatus based on the apparatus not performing the post-processing, which may extend a battery life of the apparatus.

### Example Operations of a Network Entity

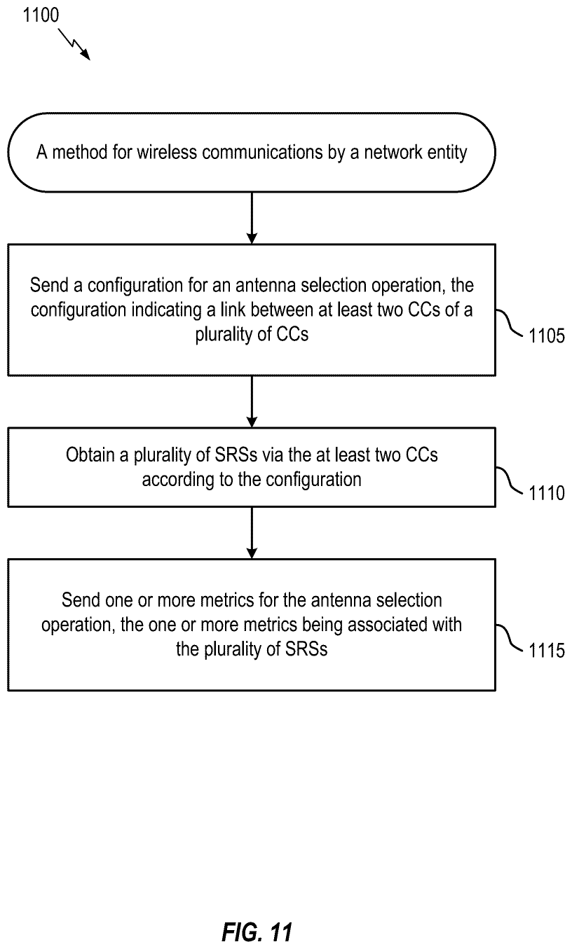

FIG. 11 shows a method 1100 for wireless communications by an apparatus, such as BS 102 of FIG. 1, a first network entity 300 or second network entity 302 of FIG. 3, or a disaggregated base station as discussed with respect to FIG. 2.

Method 1100 begins at block 1105 with sending a configuration for an antenna selection operation, the configuration indicating a link between at least two CCs of a plurality of CCs.

Method 1100 then proceeds to block 1110 with obtaining a plurality of SRSs via the at least two CCs according to the configuration.

Method 1100 then proceeds to block 1115 with sending one or more metrics for the antenna selection operation, the one or more metrics being associated with the plurality of SRSs.

In some aspects, block 1105 includes sending one or more SRS resource set configuration messages indicating a plurality of SRS resource sets and a respective linkage identifier for each of the plurality of SRS resource sets, each of the plurality of SRS resource sets is associated with a respective CC of the plurality of CCs, and the at least two CCs are linked based at least in part on each CC of the at least two CCs being associated with a same linkage identifier associated with a respective SRS resource set of the CC.

In some aspects, for each of the at least two CCs, the CC is associated with a respective SRS resource set: associated with an antenna selection usage parameter, a same number of SRS resources, and a same number of configured ports; and comprising SRS resources having same resource identifiers and same time-domain parameters.

In some aspects, block 1105 includes sending one or more configurations of one or more CC groups, and the at least two CCs are linked based at least in part on being part of a same CC group.

In some aspects, each CC of a CC group is associated with a respective SRS resource set: comprising a same number of SRS resources, a same number of configured ports, and a same SRS resource set identifier, and comprising SRS resources having same resource identifiers and same time-domain parameters.

In some aspects, block 1105 includes sending one or more SRS resource set configuration messages indicating a plurality of SRS resource sets, each of the plurality of SRS resource sets is associated with a respective CC of the plurality of CCs, each of the plurality of SRS resource sets comprises a respective one or more SRS resources corresponding to a respective time-domain resource configuration, and the at least two CCs are linked based at least in part on each of the at least two CCs being associated with a respective SRS resource set comprising a respective one or more SRS resources comprising the same time-domain resource configuration.

In certain aspects, method 1100 further includes obtaining, from a UE, capability information for the antenna selection operation.

In some aspects, the capability information comprises a number of separate antenna selection operations supported by the UE for carrier aggregation in a frequency band or a frequency band combination, a number of transmit chains and a number of antennas supported by the UE for each antenna selection operation, or both.

In certain aspects, method 1100 further includes sending, to a UE, an uplink grant comprising a triggering bit indicating for the UE to send the plurality of SRSs for the antenna selection operation.

In some aspects, the triggering bit comprises an indication of a respective SRS resource set associated with each CC of the at least two CCs, and block 1110 includes obtaining the plurality of SRSs via the at least two CCs based at least in part on the respective SRS resource set associated with each CC of the at least two CCs.

In some aspects, block 1110 includes obtaining the plurality of SRSs via the at least two CCs in a same slot indicated by the uplink grant.

In some aspects, the one or more metrics comprise per-antenna SRS-reference signal received power measurements, antenna selection results common across the at least two CCs, or a combination thereof.

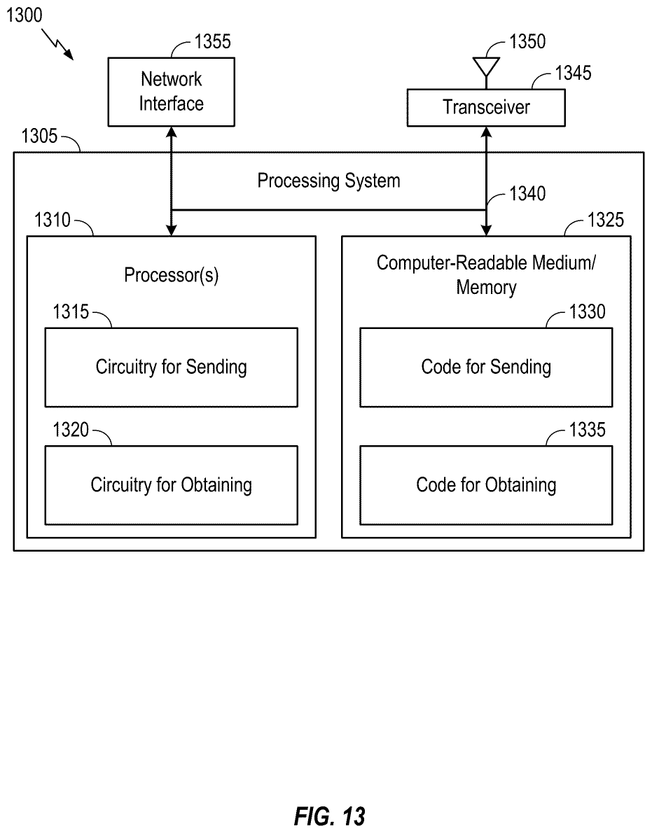

In some aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

In certain aspects, method 1100 may be performed by the apparatus to realize one or more technical effects or solutions to the aforementioned technical problem(s). For example, based on method 1100, the techniques for linking CCs for SRS transmission(s) for a common antenna selection operation may reduce signaling overhead by enabling the apparatus to send common antenna selection results (e.g., via the one or more metrics for the antenna selection operation) across multiple CCs rather than individual antenna selection results per-CC based on performing measurements of the SRS transmission(s) across the linked CCs rather than individually performing measurements of SRS transmission(s) on each CC.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, the one or more processors 1210 may be representative of the one or more processors 318 described with respect to FIG. 3. The one or more processors 1210 are coupled to a computer-readable medium/memory 1230 via a bus 1250. In some aspects, the computer-readable medium/memory 1230 may be representative of the one or more memories 320 described with respect to FIG. 3. The computer-readable medium/memory 1230 is a non-transitory computer-readable medium/memory. In certain aspects, the computer-readable medium/memory 1230 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code (e.g., executable instructions), including code for obtaining 1235, code for sending 1240, and code for applying 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry for obtaining 1215, circuitry for sending 1220, and circuitry for applying 1225. Processing with circuitry 1215-1225 may enable and cause the communications device 1200 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1345 (e.g., a transmitter and/or a receiver) and/or a network interface 1355. The transceiver 1345 is configured to transmit and receive signals for the communications device 1300 via an antenna 1350, such as the various signals as described herein. The network interface 1355 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, one or more processors 1310 may be representative of the one or more processors 308, as described with respect to FIG. 3. The one or more processors 1310 are coupled to the computer-readable medium/memory 1325 via a bus 1340. In certain aspects, the computer-readable medium/memory 1325 is configured to store instructions (e.g., computer-executable code), including code 1330 and 1335, that when executed by the one or more processors 1310, cause the one or more processors 1310 to perform the method 1100 described with respect to FIG. 11, or any aspect related to it, including any operations described in relation to FIG. 11. The computer-readable medium/memory 1325 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1325 stores code (e.g., executable instructions), including code for sending 1330 and code for obtaining 1335. Processing of the code 1330 and 1335 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1325, including circuitry for sending 1315 and circuitry for obtaining 1320. Processing with circuitry 1315 and 1320 may enable and cause the communications device 1300 to perform the method 1100 described with respect to FIG. 11, or any aspect related to it.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1345, antenna 1350, and/or network interface 1355 of the communications device 1300 in FIG. 13, and/or one or more processors 1310 of the communications device 1300 in FIG. 13.

### Example Clauses

Implementation examples are described in the following numbered clauses:
Clause 1: A method for wireless communications by a UE comprising: obtaining a configuration for an antenna selection operation, the configuration indicating a link between at least two CCs of a plurality of CCs; sending a plurality of SRSs via the at least two CCs according to the configuration; and obtaining one or more metrics for the antenna selection operation, the one or more metrics being associated with the plurality of SRSs.
Clause 2: The method of Clause 1, wherein obtaining the configuration comprises obtaining one or more SRS resource set configuration messages indicating a plurality of SRS resource sets and a respective linkage identifier for each of the plurality of SRS resource sets, each of the plurality of SRS resource sets is associated with a respective CC of the plurality of CCs, and the at least two CCs are linked based at least in part on each CC of the at least two CCs being associated with a same linkage identifier associated with a respective SRS resource set of the CC.
Clause 3: The method of Clause 2, wherein sending the plurality of SRSs comprises applying a same port-to-antenna mapping for transmission of the plurality of SRSs via the at least two CCs.
Clause 4: The method of Clause 2, wherein, for each of the at least two CCs, the CC is associated with a respective SRS resource set: associated with an antenna selection usage parameter, a same number of SRS resources, and a same number of configured ports, and comprising SRS resources having same resource identifiers and same time-domain parameters.
Clause 5: The method of any one of Clauses 1-4, wherein obtaining the configuration comprises obtaining one or more configurations of one or more CC groups, and the at least two CCs are linked based at least in part on being part of a same CC group.
Clause 6: The method of Clause 5, wherein sending the plurality of SRSs comprises applying a same port-to-antenna mapping for transmission of the plurality of SRSs via the at least two CCs in the same CC group.
Clause 7: The method of Clause 5, wherein each CC of a CC group is associated with a respective SRS resource set: comprising a same number of SRS resources, a same number of configured ports, and a same SRS resource set identifier, and comprising SRS resources having same resource identifiers and same time-domain parameters.
Clause 8: The method of any one of Clauses 1-7, wherein obtaining the configuration comprises obtaining one or more SRS resource set configuration messages indicating a plurality of SRS resource sets, each of the plurality of SRS resource sets is associated with a respective CC of the plurality of CCs, each of the plurality of SRS resource sets comprises a respective one or more SRS resources corresponding to a respective time-domain resource configuration, and the at least two CCs are linked based at least in part on each of the at least two CCs being associated with a respective SRS resource set comprising a respective one or more SRS resources comprising the same time-domain resource configuration.
Clause 9: The method of Clause 8, wherein sending the plurality of SRSs comprises applying a same port-to-antenna mapping for transmission of the plurality of SRSs in a same symbol via the at least two CCs.
Clause 10: The method of any one of Clauses 1-9, further comprising sending capability information for the antenna selection operation.
Clause 11: The method of Clause 10, wherein the capability information comprises a number of separate antenna selection operations supported for carrier aggregation in a frequency band or a frequency band combination, a number of transmit chains and a number of antennas supported for each antenna selection operation, or both.
Clause 12: The method of any one of Clauses 1-11, further comprising obtaining an uplink grant comprising a triggering bit indicating for the UE to send the plurality of SRSs for the antenna selection operation.
Clause 13: The method of Clause 12, wherein: the triggering bit comprises an indication of a respective SRS resource set associated with each CC of the at least two CCs, and sending the plurality of SRSs comprises sending the plurality of SRSs via the at least two CCs based at least in part on the respective SRS resource set associated with each CC of the at least two CCs.
Clause 14: The method of Clause 12, wherein sending the plurality of SRSs comprises sending the plurality of SRSs via the at least two CCs in a same slot indicated by the uplink grant.
Clause 15: The method of any one of Clauses 1-14, wherein the one or more metrics comprise per-antenna SRS-reference signal received power measurements, antenna selection results common across the at least two CCs, or a combination thereof.
Clause 16: The method of any one of Clauses 1-15, wherein sending the plurality of SRSs comprises sending the plurality of SRSs via the at least two CCs via a same antenna.
Clause 17: A method for wireless communications by a network entity comprising: sending a configuration for an antenna selection operation, the configuration indicating a link between at least two CCs of a plurality of CCs; obtaining a plurality of SRSs via the at least two CCs according to the configuration; and sending one or more metrics for the antenna selection operation, the one or more metrics being associated with the plurality of SRSs.
Clause 18: The method of Clause 17, wherein sending the configuration comprises sending one or more SRS resource set configuration messages indicating a plurality of SRS resource sets and a respective linkage identifier for each of the plurality of SRS resource sets, each of the plurality of SRS resource sets is associated with a respective CC of the plurality of CCs, and the at least two CCs are linked based at least in part on each CC of the at least two CCs being associated with a same linkage identifier associated with a respective SRS resource set of the CC.
Clause 19: The method of Clause 18, wherein, for each of the at least two CCs, the CC is associated with a respective SRS resource set: associated with an antenna selection usage parameter, a same number of SRS resources, and a same number of configured ports, and comprising SRS resources having same resource identifiers and same time-domain parameters.
Clause 20: The method of any one of Clauses 17-19, wherein sending the configuration comprises sending one or more configurations of one or more CC groups, and the at least two CCs are linked based at least in part on being part of a same CC group.
Clause 21: The method of Clause 20, wherein each CC of a CC group is associated with a respective SRS resource set: comprising a same number of SRS resources, a same number of configured ports, and a same SRS resource set identifier, and comprising SRS resources having same resource identifiers and same time-domain parameters.
Clause 22: The method of any one of Clauses 17-21, wherein sending the configuration comprises sending one or more SRS resource set configuration messages indicating a plurality of SRS resource sets, each of the plurality of SRS resource sets is associated with a respective CC of the plurality of CCs, each of the plurality of SRS resource sets comprises a respective one or more SRS resources corresponding to a respective time-domain resource configuration, and the at least two CCs are linked based at least in part on each of the at least two CCs being associated with a respective SRS resource set comprising a respective one or more SRS resources comprising the same time-domain resource configuration.
Clause 23: The method of any one of Clauses 17-22, further comprising obtaining, from a UE, capability information for the antenna selection operation.
Clause 24: The method of Clause 23, wherein the capability information comprises a number of separate antenna selection operations supported by the UE for carrier aggregation in a frequency band or a frequency band combination, a number of transmit chains and a number of antennas supported by the UE for each antenna selection operation, or both.
Clause 25: The method of any one of Clauses 17-24, further comprising sending, to a UE, an uplink grant comprising a triggering bit indicating for the UE to send the plurality of SRSs for the antenna selection operation.
Clause 26: The method of Clause 25, wherein: the triggering bit comprises an indication of a respective SRS resource set associated with each CC of the at least two CCs, and obtaining the plurality of SRSs comprises obtaining the plurality of SRSs via the at least two CCs based at least in part on the respective SRS resource set associated with each CC of the at least two CCs.
Clause 27: The method of Clause 25, wherein obtaining the plurality of SRSs comprises obtaining the plurality of SRSs via the at least two CCs in a same slot indicated by the uplink grant.
Clause 28: The method of any one of Clauses 17-27, wherein the one or more metrics comprise per-antenna SRS-reference signal received power measurements, antenna selection results common across the at least two CCs, or a combination thereof.
Clause 29: One or more apparatuses, comprising: one or more memories comprising executable instructions; and one or more processors configured to execute the executable instructions and cause the one or more apparatuses to perform a method in accordance with any one of Clauses 1-28.
Clause 30: One or more apparatuses configured for wireless communications, comprising: one or more memories; and one or more processors, coupled to the one or more memories, configured to cause the one or more apparatuses to perform a method in accordance with any one of Clauses 1-28.
Clause 31: One or more apparatuses configured for wireless communications, comprising: one or more memories; and one or more processors, coupled to the one or more memories, configured to perform a method in accordance with any one of Clauses 1-28.
Clause 32: One or more apparatuses, comprising means for performing a method in accordance with any one of Clauses 1-28.
Clause 33: One or more non-transitory computer-readable media comprising executable instructions that, when executed by one or more processors of one or more apparatuses, cause the one or more apparatuses to perform a method in accordance with any one of Clauses 1-28.
Clause 34: One or more computer program products embodied on one or more computer-readable storage media comprising code for performing a method in accordance with any one of Clauses 1-28.
Clause 35: One or more apparatuses configured for wireless communications, comprising: a processing system that includes one or more processors and one or more memories coupled with the one or more processors, the processing system configured to cause the one or more apparatuses to perform a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more. ” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system, the processing system comprising one or more memories and one or more processors coupled to the one or more memories, the processing system configured to cause a user equipment (UE) to:
obtain a configuration for an antenna selection operation, the configuration indicating a link between at least two component carriers (CCs) of a plurality of CCs;
send a plurality of sounding reference signals (SRSs) via the at least two CCs according to the configuration; and
obtain one or more metrics for the antenna selection operation, the one or more metrics being associated with the plurality of SRSs.

2. The apparatus of claim 1, wherein:
to cause the UE to obtain the configuration, the processing system is configured to cause the UE to obtain one or more SRS resource set configuration messages indicating a plurality of SRS resource sets and a respective linkage identifier for each of the plurality of SRS resource sets,
each of the plurality of SRS resource sets is associated with a respective CC of the plurality of CCs, and
the at least two CCs are linked based at least in part on each CC of the at least two CCs being associated with a same linkage identifier associated with a respective SRS resource set of the CC.

3. The apparatus of claim 2, wherein to cause the UE to send the plurality of SRSs, the processing system is configured to cause the UE to apply a same port-to-antenna mapping for transmission of the plurality of SRSs via the at least two CCs.

4. The apparatus of claim 2, wherein, for each of the at least two CCs, the CC is associated with a respective SRS resource set:
associated with an antenna selection usage parameter, a same number of SRS resources, and a same number of configured ports, and
comprising SRS resources having same resource identifiers and same time-domain parameters.

5. The apparatus of claim 1, wherein:
to cause the UE to obtain the configuration, the processing system is configured to cause the UE to obtain one or more configurations of one or more CC groups, and
the at least two CCs are linked based at least in part on being part of a same CC group.

6. The apparatus of claim 5, wherein to cause the UE to send the plurality of SRSs, the processing system is configured to cause the UE to apply a same port-to-antenna mapping for transmission of the plurality of SRSs via the at least two CCs in the same CC group.

7. The apparatus of claim 5, wherein each CC of a CC group is associated with a respective SRS resource set:
comprising a same number of SRS resources, a same number of configured ports, and a same SRS resource set identifier, and
comprising SRS resources having same resource identifiers and same time-domain parameters.

8. The apparatus of claim 1, wherein:
to cause the UE to obtain the configuration, the processing system is configured to cause the UE to obtain one or more SRS resource set configuration messages indicating a plurality of SRS resource sets,
each of the plurality of SRS resource sets is associated with a respective CC of the plurality of CCs,
each of the plurality of SRS resource sets comprises a respective one or more SRS resources corresponding to a respective time-domain resource configuration, and
the at least two CCs are linked based at least in part on each of the at least two CCs being associated with a respective SRS resource set comprising a respective one or more SRS resources comprising the same time-domain resource configuration.

9. The apparatus of claim 8, wherein to cause the UE to send the plurality of SRSs, the processing system is configured to cause the UE to apply a same port-to-antenna mapping for transmission of the plurality of SRSs in a same symbol via the at least two CCs.

10. The apparatus of claim 1, wherein the processing system is configured to cause the UE to send capability information for the antenna selection operation.

11. The apparatus of claim 10, wherein the capability information comprises a number of separate antenna selection operations supported for carrier aggregation in a frequency band or a frequency band combination, a number of transmit chains and a number of antennas supported for each antenna selection operation, or both.

12. The apparatus of claim 1, wherein the processing system is configured to cause the UE to obtain an uplink grant comprising a triggering bit indicating for the UE to send the plurality of SRSs for the antenna selection operation.

13. The apparatus of claim 12, wherein:
the triggering bit comprises an indication of a respective SRS resource set associated with each CC of the at least two CCs, and
to cause the UE to send the plurality of SRSs, the processing system is configured to cause the UE to send the plurality of SRSs via the at least two CCs based at least in part on the respective SRS resource set associated with each CC of the at least two CCs.

14. The apparatus of claim 12, wherein to cause the UE to send the plurality of SRSs, the processing system is configured to cause the UE to send the plurality of SRSs via the at least two CCs in a same slot indicated by the uplink grant.

15. The apparatus of claim 1, wherein the one or more metrics comprise per-antenna SRS-reference signal received power measurements, antenna selection results common across the at least two CCs, or a combination thereof.

16. The apparatus of claim 1, wherein to cause the UE to send the plurality of SRSs, the processing system is configured to cause the UE to send the plurality of SRSs via the at least two CCs via a same antenna.

17. An apparatus comprising a processing system, the processing system comprising one or more memories and one or more processors coupled to the one or more memories, the processing system configured to cause a network entity to:
send a configuration for an antenna selection operation, the configuration indicating a link between at least two component carriers (CCs) of a plurality of CCs;
obtain a plurality of sounding reference signals (SRSs) via the at least two CCs according to the configuration; and
send one or more metrics for the antenna selection operation, the one or more metrics being associated with the plurality of SRSs.

18. The apparatus of claim 17, wherein:
to cause the network entity to send the configuration, the processing system is configured to cause the network entity to send one or more SRS resource set configuration messages indicating a plurality of SRS resource sets and a respective linkage identifier for each of the plurality of SRS resource sets,
each of the plurality of SRS resource sets is associated with a respective CC of the plurality of CCs, and
the at least two CCs are linked based at least in part on each CC of the at least two CCs being associated with a same linkage identifier associated with a respective SRS resource set of the CC.

19. The apparatus of claim 17, wherein:
to cause the network entity to send the configuration, the processing system is configured to cause the network entity to send one or more configurations of one or more CC groups, and
the at least two CCs are linked based at least in part on being part of a same CC group.

20. A method for wireless communications by a user equipment (UE) comprising:
obtaining a configuration for an antenna selection operation, the configuration indicating a link between at least two component carriers (CCs) of a plurality of CCs;
sending a plurality of sounding reference signals (SRSs) via the at least two CCs according to the configuration; and
obtaining one or more metrics for the antenna selection operation, the one or more metrics being associated with the plurality of SRSs.
